(19) United States
(12) Patent Application Publication
(10) Pub. No.: US 2013/0103497 A1
(43) Pub. Date: Apr. 25, 2013

(54) Method of Creating, Cataloging, and Retrieving Commercial Advertising Wiki Pages with Keywords through an Online Software Application

(71) Applicant: Kwang Hyun CHO, Seoul (KR)

(72) Inventor: Kwang Hyun CHO, Seoul (KR)

(21) Appl. No.: 13/454,082

(22) Filed: Apr. 23, 2012

Related U.S. Application Data
(60) Provisional application No. 61/478,191, filed on Apr. 22, 2011.

(51) Int. Cl. G06Q 30/02

(52) U.S. Cl. CPC G06Q 30/0256
USPC 705/14.54

(57) ABSTRACT

A online software application allows users to create, catalog, and retrieve commercial advertising wiki pages with keywords. The software can be accessed by three kinds of accounts: admin accounts, first tier accounts, and second tier accounts. An admin account is used to manage the first tier accounts and the second tier accounts. The second tier accounts are also managed by the first tier accounts and are used by wholesalers of advertisements and sponsors to create an wiki page. The wiki page is allows the wholesaler to promote its collection of advertisements and sponsors. The software is implemented into common search engines so that a random client of a search engine can click on a link to the wiki page when a random client searches for a specific keyword. The software is used to view, purchase, and manage keywords, each of which is linked to only one wiki page.

The current application is a non-provisional application and claims a priority to the U.S. provisional patent application Ser. No. 61/478,191 filed on Apr. 22, 2012. The current application is filed on Apr. 23, 2012 while Apr. 22, 2012 was on a weekend.

### FIELD OF THE INVENTION

The present invention relates generally to internet advertisement method making use of purchased keywords to link internet surfers to a formatted webpage advertising the products of wholesalers.

### BACKGROUND OF THE INVENTION

Unlike the existing advertisements on the web, the present invention does not directly deal with advertisers; rather, it deals only with wholesalers (Tier 2). Wholesalers (Tier 2) will gather sponsors or advertisers using their sales force. Wholesalers (Tier 2) will purchase a keyword or a list of keywords from the present invention and will use an assigned wiki page (one page per keyword). They can format their wiki pages in free format. Their options include but are not limited to blog type of advertisement, embedding Flash or Silverlight, and any other styles that wiki can provide. When a keyword is searched using a search engine (the present invention would also be able to be embedded into any kind of search engine), search results display the present invention. (The size of the present invention display would be adjustable.)

### BRIEF DESCRIPTION OF THE DRAWINGS

FIG. 1 is a view of the present invention presenting an ad page link.

FIG. 2 is a view of the present invention presenting an ad page link.

FIG. 3 is a view of the present invention presenting an ad page link defining a wiki link.

FIG. 4 is a view of the wiki link advertised by a wholesaler.

FIG. 5 is a view of a keyword being entered into a search engine.

FIG. 6 is a flow chart showing the search request being sent to the web server.

FIG. 7 is a view of the search results displayed by the present invention.

FIG. 8 is a view of an example for the account registration process.

FIG. 9 is a view of the example for the time zone and currency preference page for the registration process.

FIG. 10 is a view of the example for the verification of registration.

FIG. 11 is a view of the example for a confirmation email of the registration.

FIG. 12 is a view of the example for a welcome screen for the verification.

FIG. 13 is a view of the example for a homepage that allows users to manage their accounts.

FIG. 14 is a screen capture of a different example for a registration process.

FIG. 15 is a preview screen of a wiki page awaiting approval by an admin account.

FIG. 16 is a view of the management screen.

FIG. 17 is the assignment report sub-menu for the keyword page.

FIG. 18 is a view of the details of a keyword being managed by the user.

FIG. 19 is a view of the lookup sub-menu for the keyword page.

FIG. 20 is a view of the manage keyword sub-menu for the keyword page.

FIG. 21 is a view of the assignment reports sub-menu for the keyword page.

FIG. 22 is a view of the accounts management page for updating an account.

FIG. 23 is a view of the accounts management page for creating a new account.

FIG. 24 is a view of the transaction page.

### DETAILED DESCRIPTIONS OF THE INVENTION

All illustrations of the drawings are for the purpose of describing selected versions of the present invention and are not intended to limit the scope of the present invention.

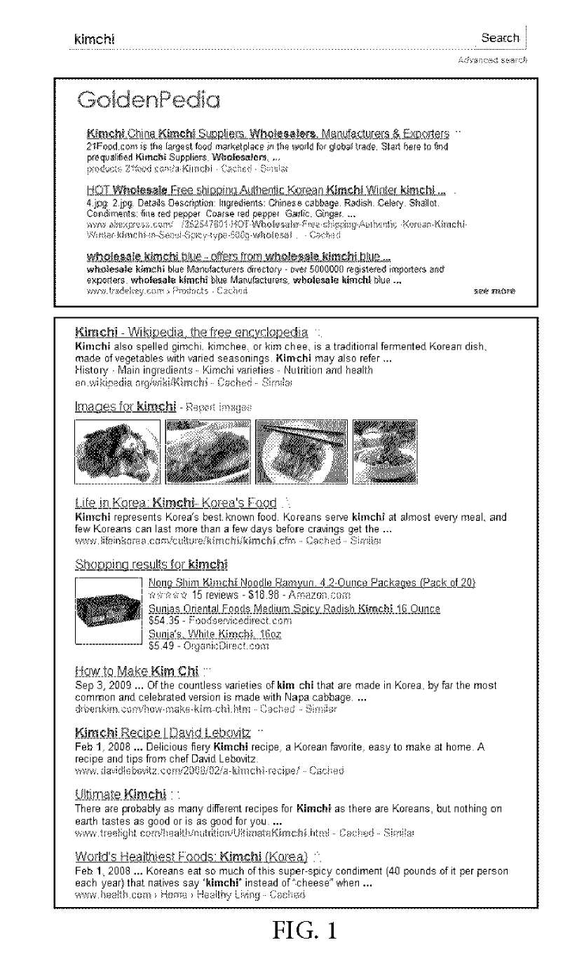

The present invention is a method of creating, cataloging, and retrieving commercial advertising wiki pages with keywords through an online software application. In reference to FIG. 1, since wiki style pages are easily crawled by search engine crawlers, the present invention will utilize the wiki format of advertising that will easily exposed the content of the advertising to search engines. Therefore, additional tuning of SEO (search engine optimization) will be an important requirement for further development.

The present invention can be accessed by three different kinds of accounts: an admin account, a first tier account, and a second tier account. The admin account is used by administrators of the present invention, who have full rights and access to the present invention's management pages. The first tier account is used by tier 1 companies, which are companies that will manage tier 2 companies. The tier 2 companies are wholesalers that are managed by the tier 1 companies and access the present invention through a second tier account.

An example scenario for using the present invention is as followed:
1. The prospects of wholesalers (Tier 2) can inquire about any keyword via the present invention's home page or through sales personnel. Before purchasing a keyword, the wholesaler must create a second tier account.
2. Once a keyword is purchased, the buyer becomes a wholesaler.
3. An advertisement wiki page will be allocated to the purchased keyword.
4. The wholesaler must gather sponsors or advertisers using its own sales forces.
5. The wholesaler will develop the allocated advertisement wiki page. Once the advertisement wiki page is done, it must be approved by an administrator.
6. An administrator will review the submitted advertisement wiki page to make sure it meets the present invention's business policy. Once approved by the administrator, the advertisement wiki page will be available immediately.
7. Editing an advertisement wiki page does not require an approval phase, but it is subject to review. If the advertisement wiki page has any complaints or if it does not meet the business policy, then the advertisement wiki page can be suspended and will require approval from an administrator.

### Business Requirements

The present invention can include different business requirements. The first type is a keyword-related contract. There are two types of keywords: regular and premium. The price of the keywords is set with different criteria. Regular keywords can be purchased from the present invention's website. The price of regular keywords will be determined by semantic technologies and will be based on trend and popularity of keyword ontology. The price of premium keywords will be manually assigned by the administrators, and wholesalers' (Tier 2) prospects can purchase them from the sales personnel. The second type of business requirement is based on duration of contracts and conditions. The contract term is the length of time that the contract is in effect. In the preferred embodiment of the present invention, the contract term is either six months or one year. The length of the contract term is directly proportional to the applied discount. During the length of the contract, the present invention does not guarantee any number of clicks and ad views. In addition, the wholesalers (Tier 2) will not get charged for additional fees even if their click-through rates become high or the recognition of their keywords becomes popular. However, wholesalers may be requested to pay a higher premium when they renew their contract if the number of clicks has become higher than what was specified in the original contract. Also, if a different wholesaler places a higher bid on a keyword, then the original wholesaler must pay an equal or higher amount than the higher bid in order to keep its keyword.

### Technical Requirements

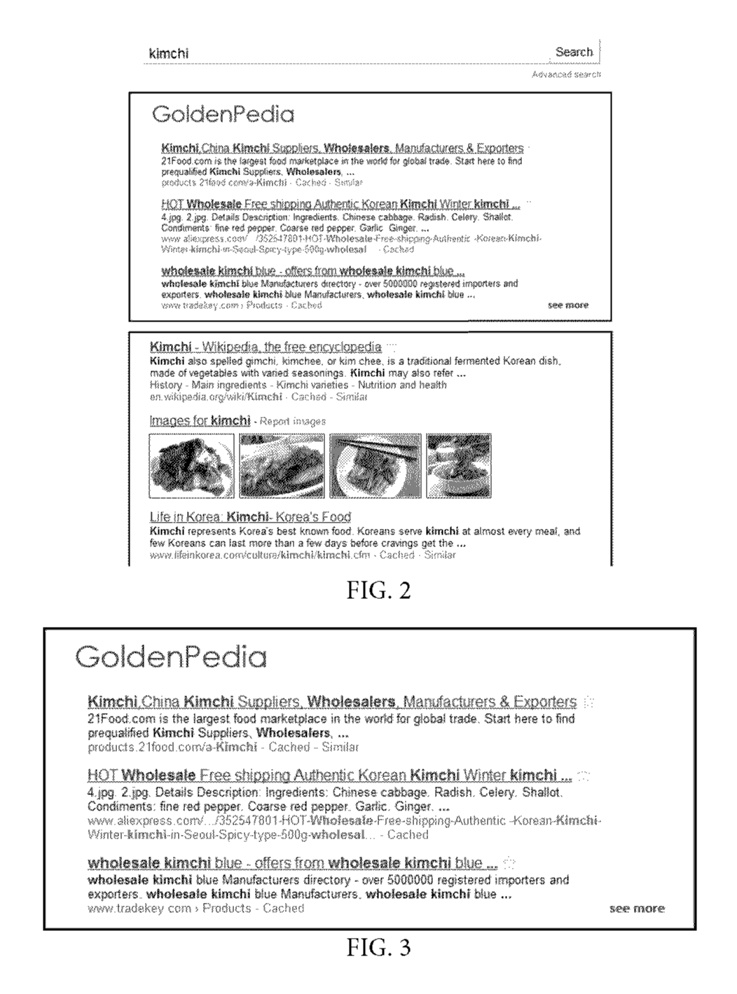

When a client uses a search engine that implements the present invention and the search request by the client corresponds to a keyword that is registered with the present invention, the client will be able to see related advertisements with the search results of the search engine. The related advertisements will be displayed at the top of the page or right below the heading of the page. In reference to FIG. 2, the present invention has an implementation widget that will capture the following information: the number of times that each keyword is displayed by the present invention, a list of related advertisements that have been displayed by the present invention, and the number of clicks on each related advertisement. Multiple related advertisements will be displayed for each keyword. In the example shown in FIG. 2, the implementation widget is displaying three related advertisements. The captured information will be stored within a database for the present invention so that the administrators and the wholesaler will be able to view and query the captured information. The results pane of present invention may develop as a widget or as a control so that any search engine can easily use the widget or the control as a plug-in. When the present invention yields no results, the results panel will be hidden.

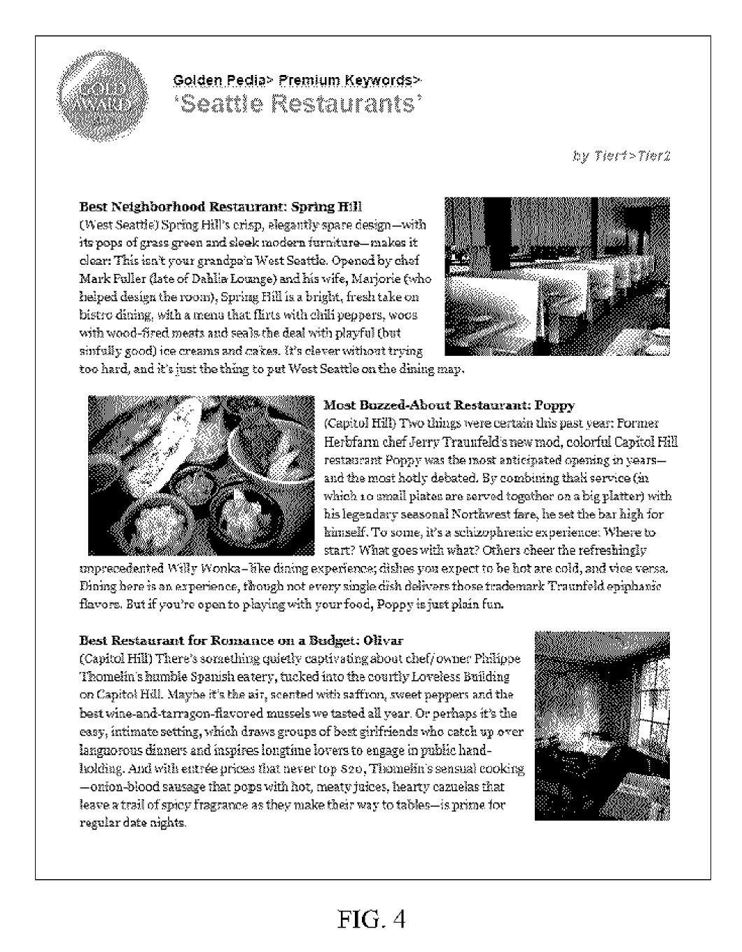

In reference to FIG. 3, a description for each related advertisement will be extracted and displayed on the results panel. If the definition is too long and cumbersome to fit into the results panel, then a portion of the description for each related advertisement will be replaced with “ . . . ” to see the remaining portion of the description. The client can click on the links for the related advertisements. When a see-more link is clicked by the client, the page will be redirected to the advertisement wiki page, as shown in FIG. 4. When designing the implementation widget, the following options can be considered:
IFrame (Should not use due to performance reasons)
Inline Javascript (Should not use due to performance reasons)
Server Control, which should be developed separately based on the technologies used by the search engine. The present invention's Windows Communication Foundation (WCF) service will impact the overall performance of search results.
   For the users of the present invention, the minimum requirements of an application programming interface (API) or the implementation widget include input parameters (source of the search engine and list of search keywords), notifications to the WCF service when related advertisements are shown to clients using a search engine, and notifications to the WCF service when a related advertisement is clicked by the clients.

All requests related to present invention will be handled on the server side. Search results from the search engine and the related advertisements will be displayed at the same time. However, the performance of search engine could be impacted by present invention. Each search engine provider or the present invention's engineers should develop or a unique implementation widget for each search engine platform.

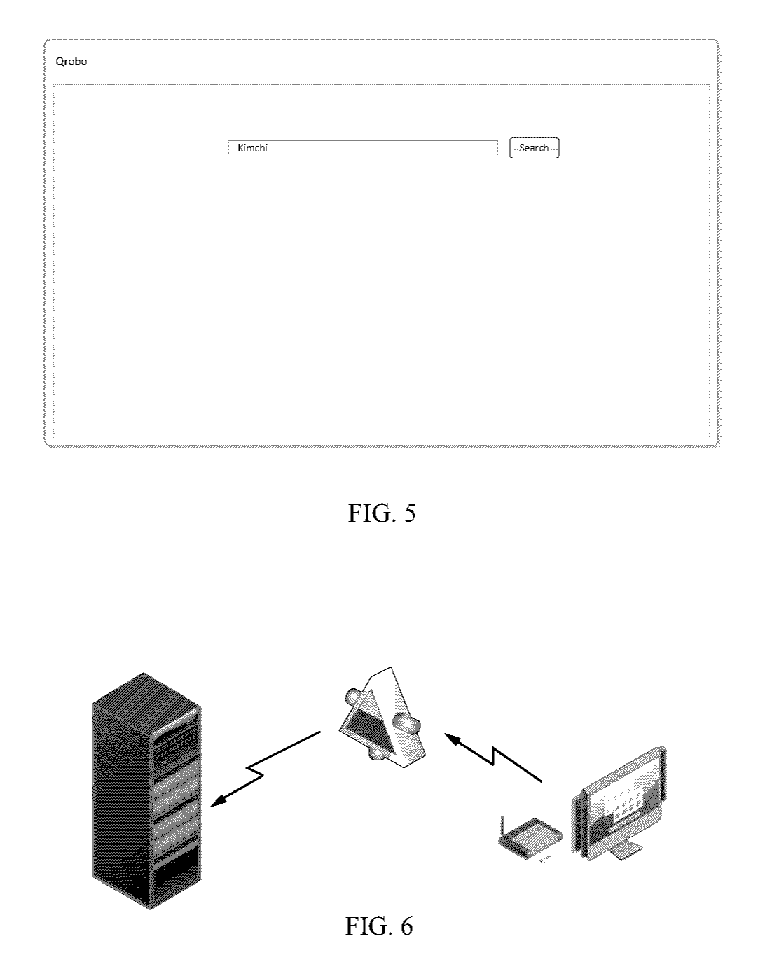

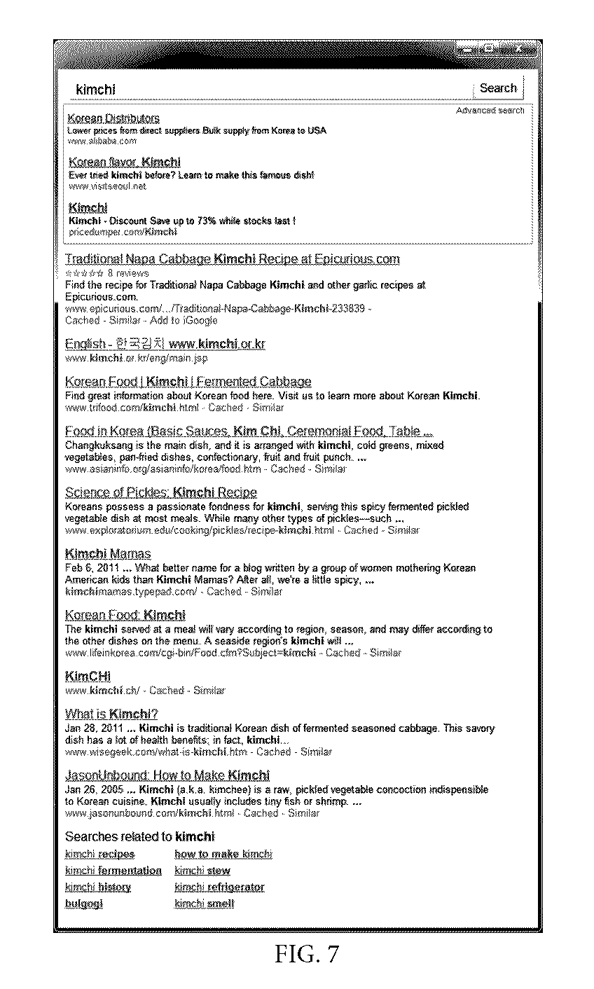

In reference to FIG. 5-7, the present invention retrieves a search request from a search engine though a client browser, which is used by a client to access the search engine and present invention. The search request is then sent to a web server, which will process the search results. The search request then injects or enables the server control. The present invention will then populate all of the required parameters and send the search request to the WCF service in order to find matching keyword and its related advertisements. The related advertisements are retrieved from the WCF service and are used to populate the results from the present invention. Those results are displayed along with search results from the search engine.

All of the related advertisements will be retrieved via WCF service. The handling of cache efficiently is very important. The present invention will make use of the cache strategies including HTTP Context Output Cache and In-Memory Cache or Cache Machine. For HTTP context output cache, result sets should be cached based on query string using HTTP Cache Policy, as shown in the following example:

HttpContext Cotext=HttpContext.Current;

HttpCachePolicy c-HttpContext.Current.Response.Cache;

c.SetCacheability(HttpCacheability.ServerAndPrivate);

c.SetExpires(HttpContext.Current.Timestamp.AddSeconds(60));

c.VaryByHeaders[“Accept”]=true;

c.VaryByHeaders[“Accept-Charset”]=true;

c.VaryByHeaders[“Accept-Encoding”]=true;

c.VaryByParams[“*”]=true;

For In-Memory Cache or Cache Machines, all core data should be pre-populated into in-memory cache, a cache machine (AppFabric A.K.A. Velocity), or a combination of both. Data will be periodically refreshed in a background thread.

The present invention could also make use of a WCF data service. In case the present invention uses Inline Javascript is chosen instead of server control, the present invention will call the WCF data service, and the server will return either JSON format or RSS. The present invention makes use of static data. Therefore, there is no need to call the database per each request. There is then a need to handle underline plumbing of data handling. The classic WCF will be available regardless of WCF data service.

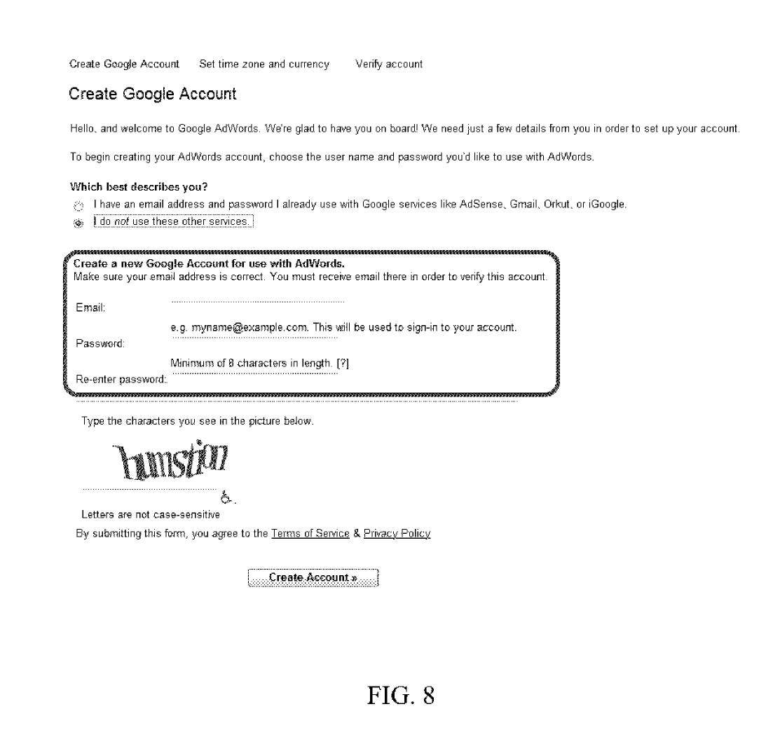

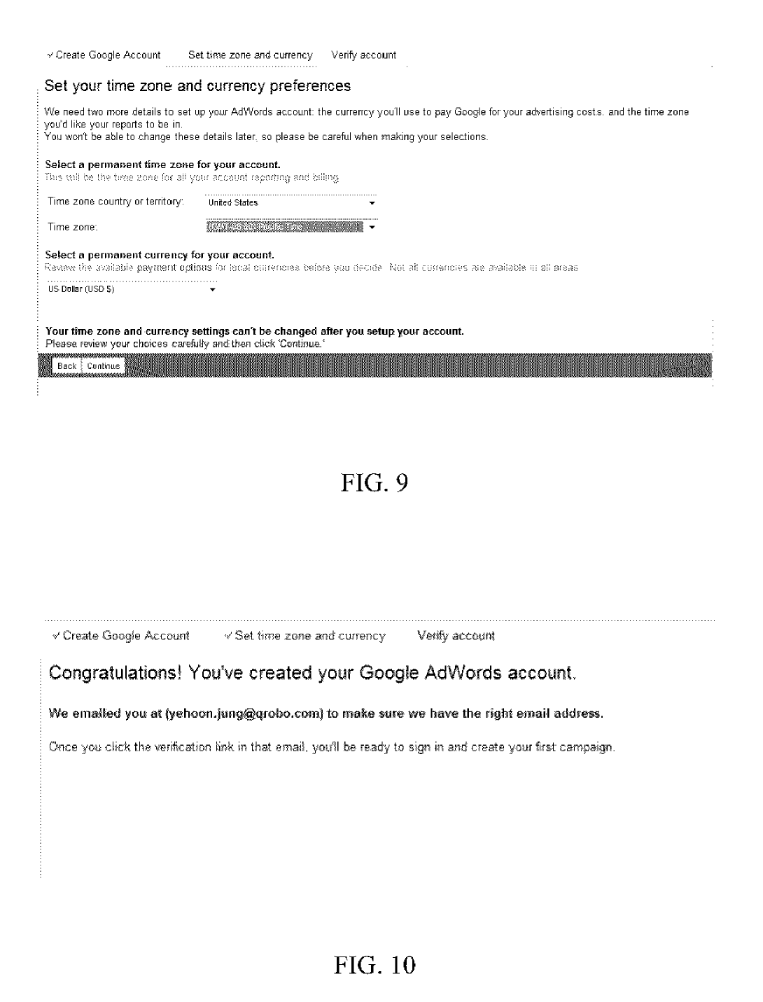

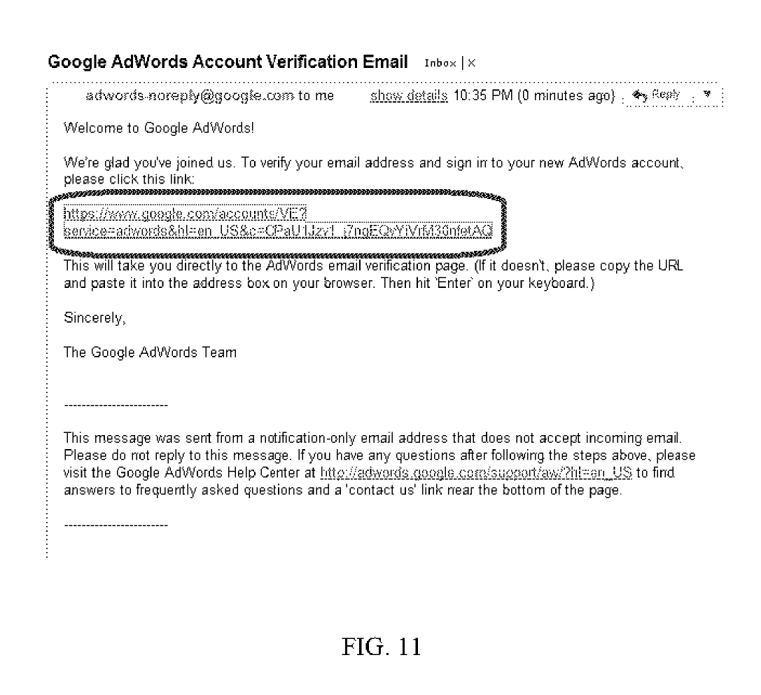

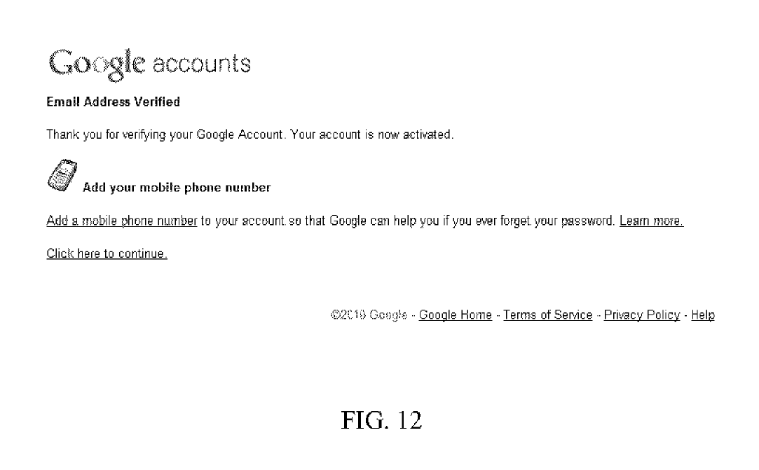

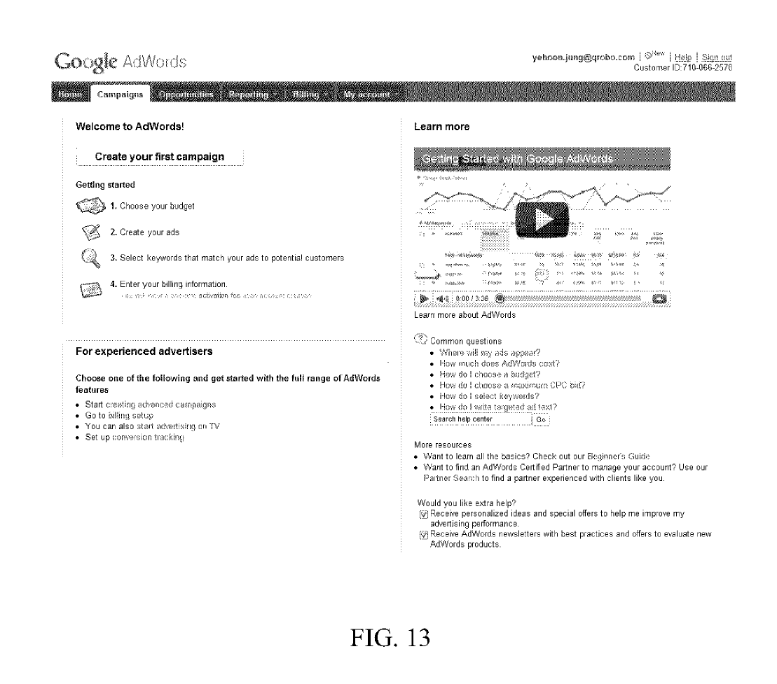

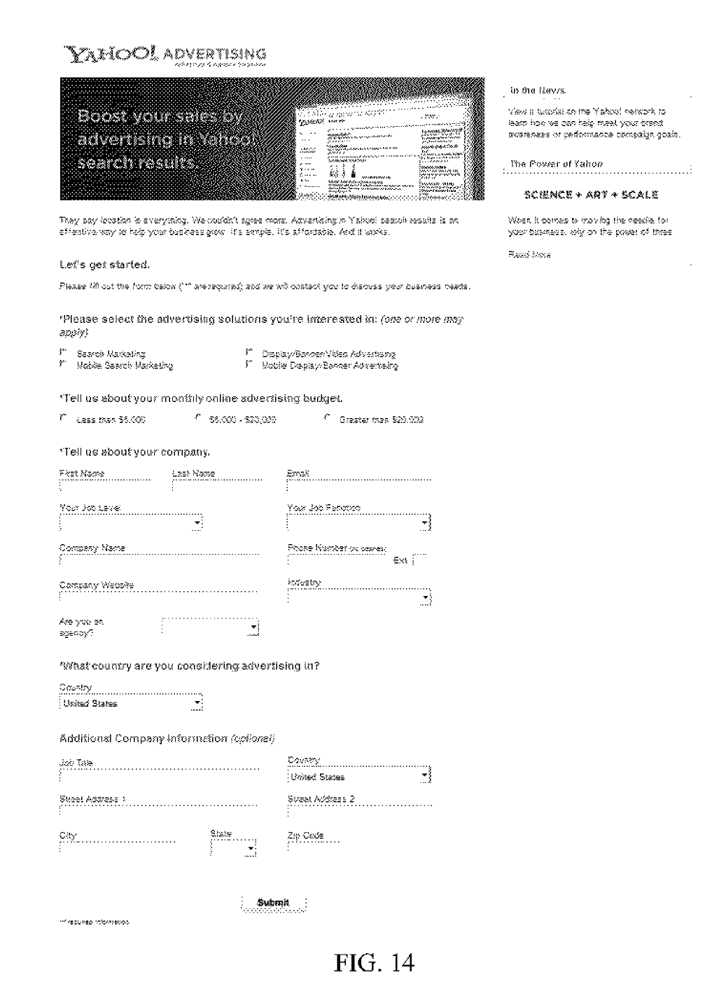

In order to create an account and purchase keywords on the present invention, the tier 2 companies will contact tier 1 companies or the administrators. In other words, the present invention allows the admin account to create both first tier accounts and second tier accounts and allows the first tier accounts to create a second tier account. A wholesaler should be able to purchase keyword(s) through the present invention's market place. Premium keywords should be purchased through sales personnel and need to have the separate requesting web page. After purchasing a keyword, a wholesaler should be able to access the advertising wiki page using a registered account ID. The present invention employs the registering process of: 1.) creating an account by entering and email address and a password; 2.) retrieving locale data, which includes location, time zone, and currency type; and 3.) verifying the account by sending a confirmation link to their email address and prompting them to activate the confirmation link. The registering process is also shown FIG. 8-13. Once the registration process is completed, a verification email is sent to the user. The email will contain a confirmation link. When the confirmation link is clicked, the user will be redirected to the following welcome screen (example in FIG. 12). After registration, the home page shown in FIG. 13 is an example of what is shown the user.

The present invention will allow users to be able to search for a keyword along with a price tag and other detailed information. Once a keyword is purchased, the information including expiration date, purchased amount, and bidding options with a higher amount is accessible by the tier 1 wholesaler. When a user bids a higher amount than the existing wholesaler, the wholesaler will be notified via email and letter if necessary. All bidders will be notified if there is a new higher bidder. After the selection of a keyword, the user should be able to enter credit card information. The present invention can use other websites to process credit card information. Implementing a credit card processing system along with management may take a longer amount of time, so the present invention can start implementing this feature after P0 features are completed. Until then, the present invention can collect user information from the web and sales personnel can follow up on the user. In this case, the present invention still need to process credit card information but will be manually enter the credit card information.

A wholesaler can use the advertisement wiki page to come up with an advertisement. The present invention could provide ad design services to the tier 1 and tier 2 companies. The fee for the ad design service will depend on the amount of design effort.

For the advertisement wiki pages, the tier 2 companies will be assigned one advertisement wiki page per keyword. The feature to record is the total number of views for each advertisement wiki page. This information will be stored in the database, and the first tier account, the second tier account, and the admin account should be able to review that information from a management screen. The present invention may use analytics from a different website to collect user activities.

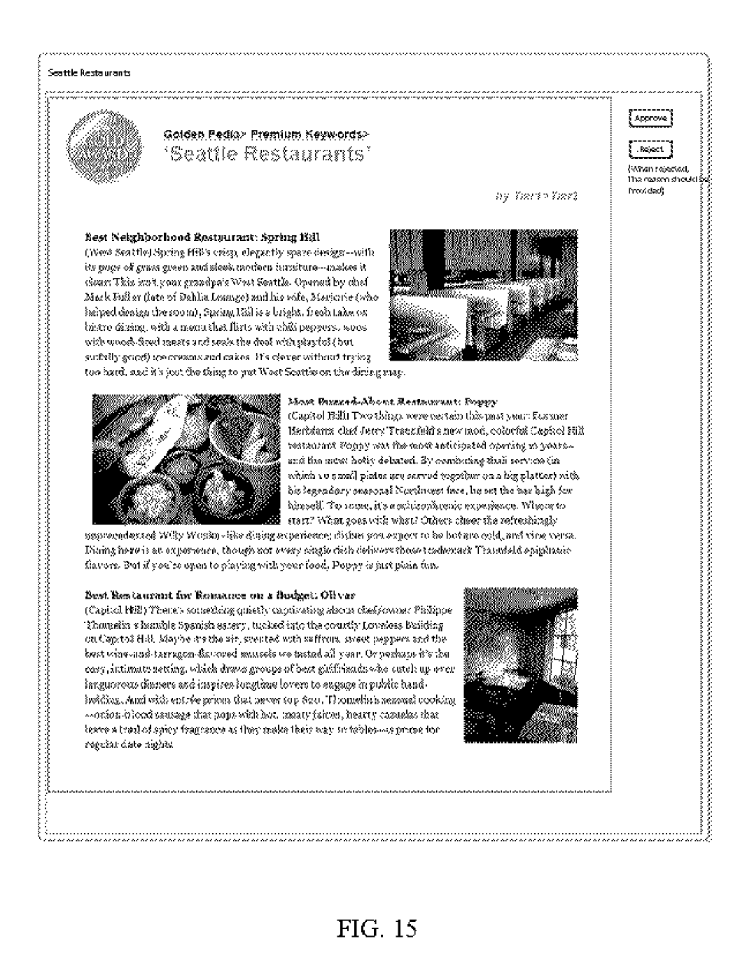

Newly registered advertisement wiki pages or modified advertisement wiki pages will be verified by the administrators. The tier 2 companies will modify the advertisement wiki pages until the administrator approves the advertisement wiki page. The administrators will be notified via email about modifications to the advertisement wiki pages. The email will included a link that will direct the administrator to the modified advertisement wiki page, which would allow the administrator to review the modified advertisement wiki page. The administrator will then have to option to approve or reject the modifications as shown in FIG. 15. If the modified advertisement wiki page is rejected by the administrator, then the tier 2 user should redesign the advertisement wiki page according to the present invention's policy and resubmit the advertisement wiki page to the administrator. Once the advertisement wiki page is approved by the administrator, the modified version of the advertisement wiki page will be displayed. The approval or rejection could be processed via the management screen.

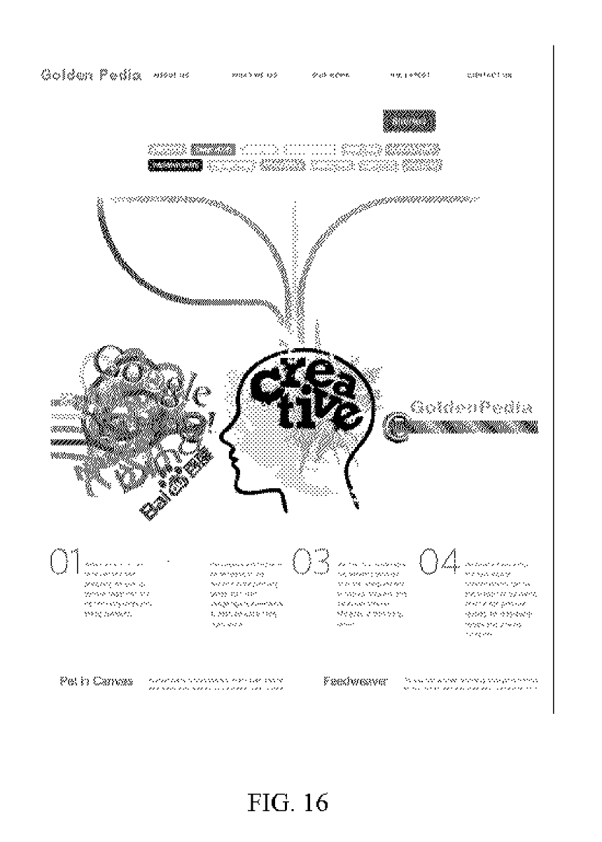

In reference to FIG. 16, the present invention's homepage should be used by the administrator, the tier 1 user, and the tier 2 user. The homepage contains information about present invention and could be used as sales material for the present invention. The first tier account and the second tier account must be created before accessing the management screen. The user accounts will be manually created and will follow these restrictions: the first tier accounts must be created by an admin account and the second tier accounts must be created by the first tier accounts.

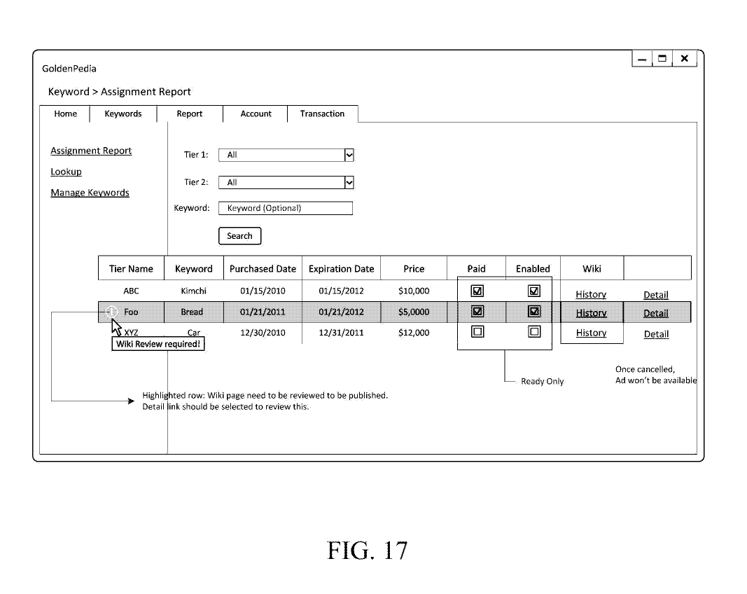

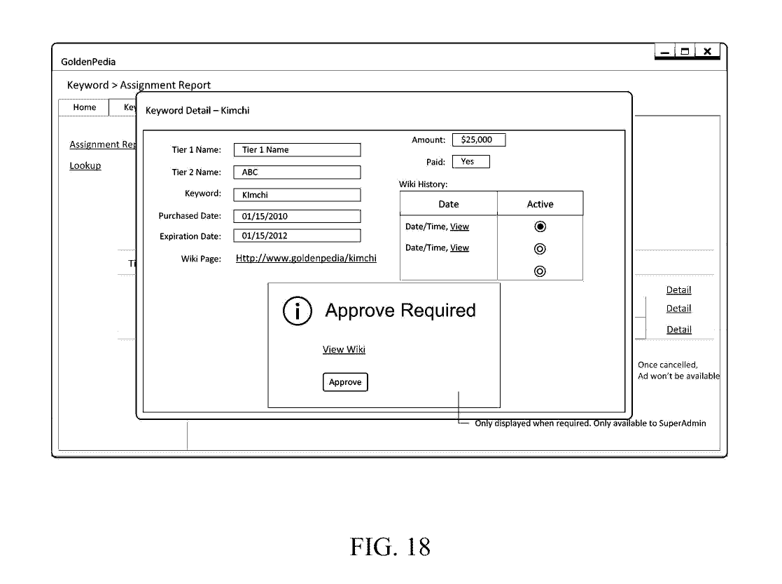

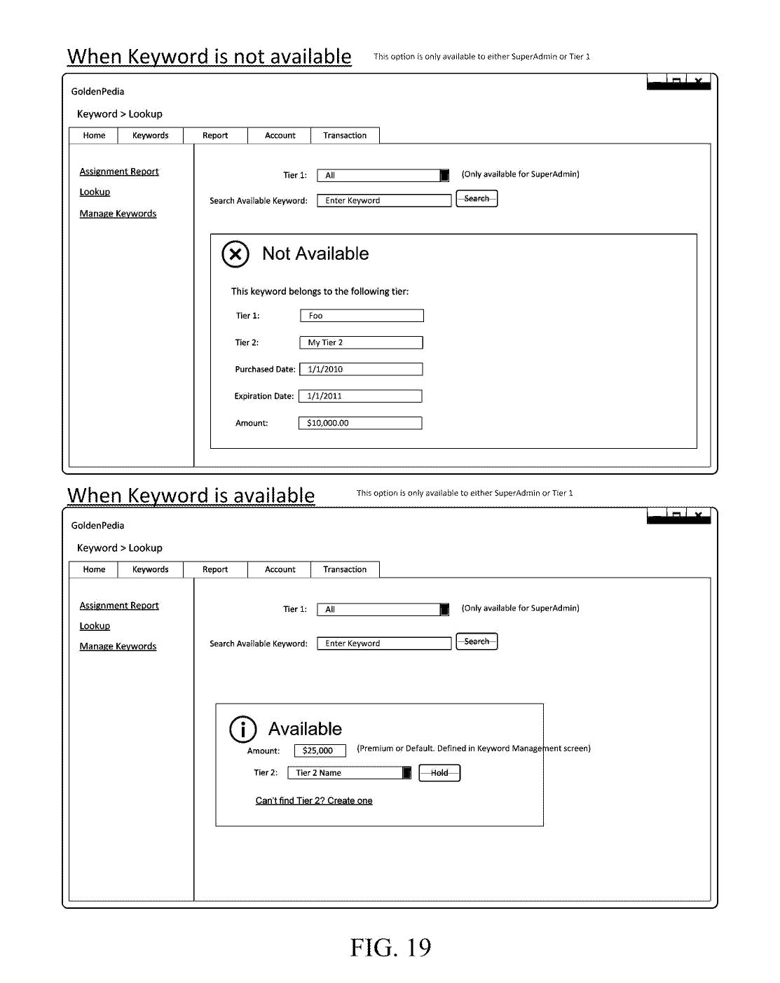

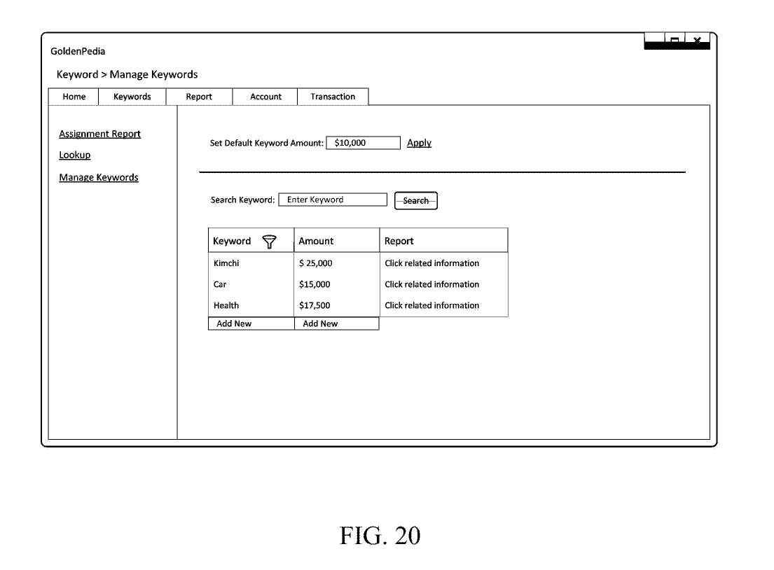

The management screen will have the sub-menus for keywords, reports, accounts, and transactions. The keyword page will have three sub-menus including assignment reports, lookup, and manage keywords. The assignment reports page will allow users to see a list of keywords as well as purchased date, expiration date, price, payment status, enabled status, and the history of wiki pages. The purchase date and the expiration data are known as the length of the contract term. In reference to FIG. 17, the assignment report page will also allow users to control the areas including the enabling and disabling of keywords, approval or rejection of advertisement wiki pages, and the activation of a different advertisement wiki page from the history of wiki pages. In reference to FIG. 18, the keywords displayed can also be viewed in detail by means of clicking a “Detail” link corresponding to each keyword. In reference to FIG. 19, the lookup feature will allow users to view the availability of a keyword and purchase it. The WCF service stores a list of unavailable keywords, and the list of unavailable keywords is updated with a specific keyword if that specific keyword is purchased. Once a specific keyword is purchased, the second tier account must pay within a certain period of time, usually one month. Otherwise, the second tier account will be disabled, and the keyword will become available to other second tier accounts. The advertisement wiki page will not be available until the keyword is marked as “paid”. If the keyword is marked as “paid”, then the specific keyword will be added to the plurality of acquired keywords for the second tier account. In reference to FIG. 20, in order to manage the keywords, the user will set amounts for the default keyword. All default keywords are not stored in a database. The user will create new premium keyword along with a set amount. The user will also be able to modify the amount of the existing keyword. When modified and this keyword is already assigned, a new price will be applied when renewed and must support history of price changes.

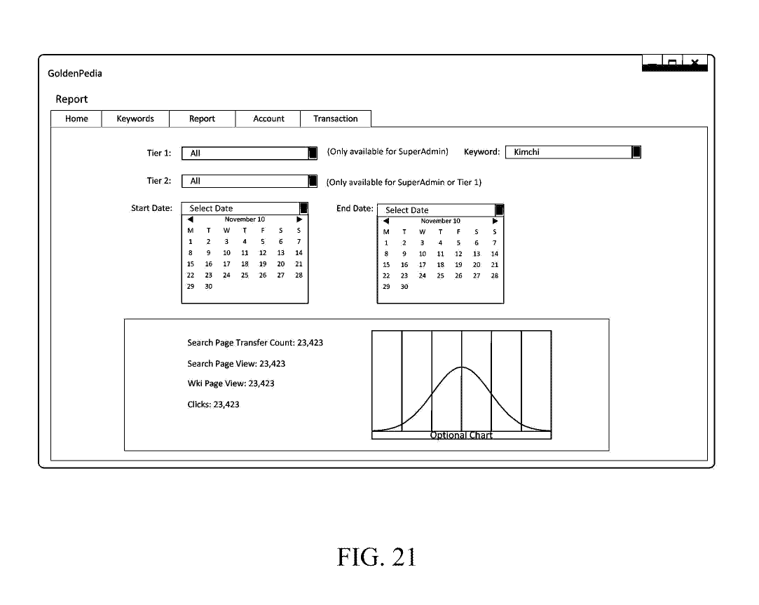

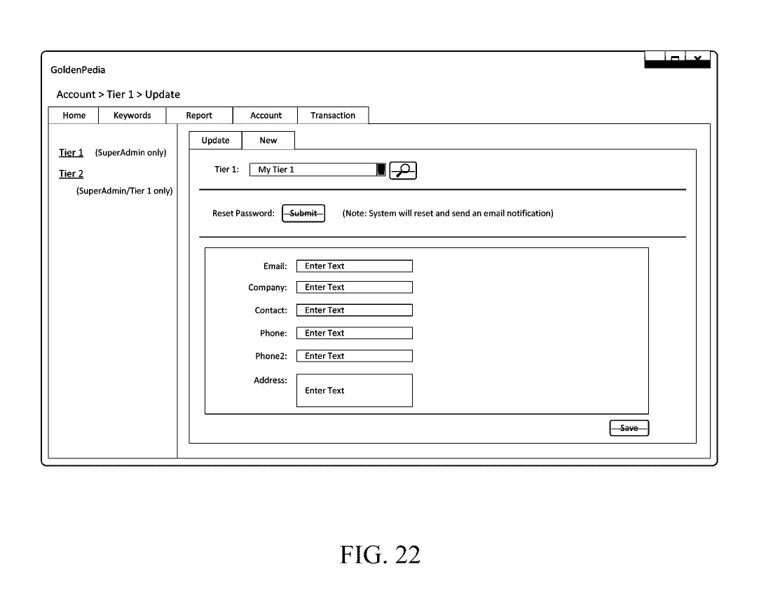

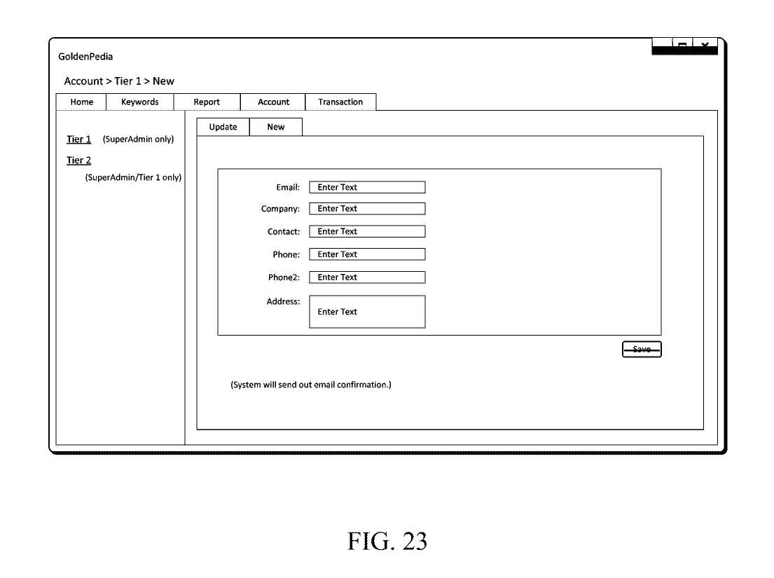

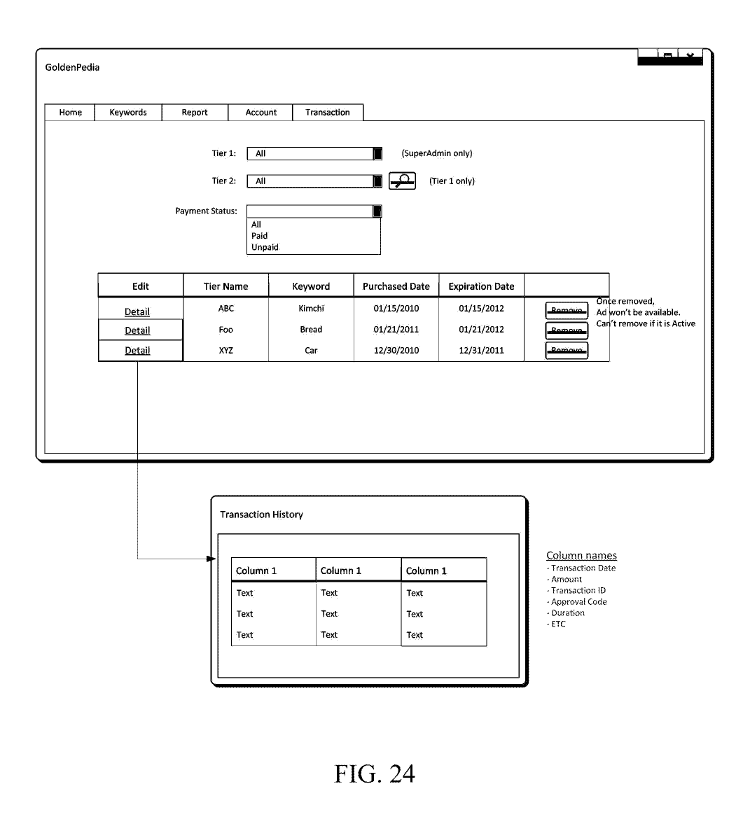

In reference to FIG. 21, the report page will support search page transfer counts, search page view, wiki page views, and clicks on the related advertisements, which is known as performance data. The present invention will continuously record the performance data of each acquired keyword for a first tier account or a second tier account. In reference to FIG. 22-23, the accounts page will allow the creation or modification of new user accounts and will be applied to the creation of first tier accounts and second tier accounts. In reference to FIG. 24, the user is able to manage transactions.

Although the invention has been explained in relation to its preferred embodiment, it is to be understood that many other possible modifications and variations can be made without departing from the spirit and scope of the invention as hereinafter claimed.

What is claimed is:

1. A method of creating, cataloging, and retrieving commercial advertising wiki pages with keywords by executing computer-executable instructions stored on a non-transitory computer-readable medium, the method comprises the steps of:
providing a Windows Communication Foundation (WCF) service, wherein said WCF service stores a list of unavailable keywords;
providing a first tier account, a second tier account, and an admin account, wherein said first tier account manages said second tier account;
newly creating said first tier account or said second tier account;
providing said first tier account and said second tier account with a keyword page, wherein said keyword page includes an assignment report sub-page, a lookup sub-menu, and a managing keywords sub-menu;
enabling said first tier account and said second tier account to manage a plurality of acquired keywords through said keyword page;
enabling said first tier account and said second tier account to add a specific keyword to said plurality of acquired keywords;
enabling said second tier account to construct an advertisement wiki page after receiving a payment for said specific keyword;
retrieving a search request from a search engine through a client browser, wherein said search engine has an implementation widget;
sending said search request to a web server to process said search results;
displaying search results with related advertisements and a see-more link, if said search request corresponds to said specific keyword;
redirecting to and displaying said advertisement wiki page of said specific keyword, if said see-more link is activated through said client browser; and
continuously recording performance data for each of said plurality of acquired keywords.

2. The method of creating, cataloging, and retrieving commercial advertising wiki pages with keywords by executing computer-executable instructions stored on a non-transitory computer-readable medium, the method as claimed in claim 1 comprises the steps of:
prompting said admin account to create said first tier account;
enabling said first tier account to enter preliminary settings;
prompting said admin account or said first tier account to create said second tier account; and
enabling said second tier account to enter said preliminary settings.

3. The method of creating, cataloging, and retrieving commercial advertising wiki pages with keywords by executing computer-executable instructions stored on a non-transitory computer-readable medium, the method as claimed in claim 2 comprises the steps of:
retrieving an email address and a password from both said first tier account and said second tier account;
retrieving locale data from both said first tier account and said second tier account, wherein said locale data includes location, time zone, and currency type;
sending confirmation link to said email address of said first tier account and said email address of said second tier account;
prompting said first tier account to verify identity by activating said confirmation link; and
prompting said second tier account to verify identity by activating said confirmation link.

4. The method of creating, cataloging, and retrieving commercial advertising wiki pages with keywords by executing computer-executable instructions stored on a non-transitory computer-readable medium, the method as claimed in claim 1 comprises the steps of:
enabling said first tier account and said second tier account to search through said list of unavailable keywords for said specific keyword through said lookup sub-menu;
displaying ownership, contract term, and price of said specific keyword, if said specific keyword is on said list of unavailable keywords;
retrieving ownership, contract term, and price of said specific keyword from said first tier account or said second tier account, if said specific keyword is not on said list of unavailable keywords;
receiving said payment for said specific keyword from said first tier account or said second tier account through said lookout sub-menu;
adding said specific keyword to said plurality of acquired keywords; and
updating said list of unavailable keywords with said specific keyword.

5. The method of creating, cataloging, and retrieving commercial advertising wiki pages with keywords by executing computer-executable instructions stored on a non-transitory computer-readable medium, the method as claimed in claim 4 comprises the step of:
enabling said first tier account or said second tier account to bid a higher price for said specific keyword when said contract term comes to an end, if said specific keyword is on said list of unavailable keywords.

6. The method of creating, cataloging, and retrieving commercial advertising wiki pages with keywords by executing computer-executable instructions stored on a non-transitory computer-readable medium, the method as claimed in claim 4 comprises the steps of:
enabling said first tier account or said second tier account to view said contract term, said price, payment status, enabled status, and wiki page history of each of said plurality of acquired keywords through said managing keywords sub-menu;
enabling said first tier account or said second tier account to enable or disable said specified keyword through said managing keywords sub-menu;
enabling said first tier account or said second tier account to approve or reject said advertisement wiki page of said specified keyword through said managing keywords sub-menu; and
enabling said first tier account or said second tier account to activate an alternate advertisement wiki page for said specific keyword through said managing keywords sub-menu.

7. The method of creating, cataloging, and retrieving commercial advertising wiki pages with keywords by executing computer-executable instructions stored on a non-transitory computer-readable medium, the method as claimed in claim 1 comprises the steps of:
receiving said advertisement wiki page for said specified keyword from said second tier account;
notifying said admin account to view said advertisement wiki page and prompting said admin account to accept or decline said advertisement wiki page;
prompting said second tier account to modify and resubmit said advertisement wiki page for review by said admin account, if said admin account declines said advertisement wiki page; and
activating said advertisement wiki page, once said admin account approves said advertisement wiki page.

8. The method of creating, cataloging, and retrieving commercial advertising wiki pages with keywords by executing computer-executable instructions stored on a non-transitory computer-readable medium, the method as claimed in claim 1 comprises the steps of:
activating said implementation widget when said web server processes said search results;
sending said search request to said WCF service in order to find matching keyword and said related advertisements;
retrieving said related advertisements from said WCF service; and
displaying said list of related advertisements along with said search results on said client browser.

9. The method of creating, cataloging, and retrieving commercial advertising wiki pages with keywords by executing computer-executable instructions stored on a non-transitory computer-readable medium, the method as claimed in claim 1 comprises the steps of:
enabling said first tier account or said second tier account to access and view said performance data for each of said plurality of acquired keywords through a report screen, wherein said performance data includes a search page transfer count, a number of search page views, a number of wiki pages views, and a number of clicks; and
graphically displaying said performance data of each of said plurality of acquired keywords to said first tier account or to said second tier account.
